(19) United States
(12) Patent Application Publication
(10) Pub. No.: US 2025/0242267 A1
(43) Pub. Date: Jul. 31, 2025

(54) HORIZONTAL CHARGING STAND FOR PS5 CONSOLE

(71) Applicant: Guangzhou Zhongtianxin Electronic Technology Co.,Ltd, Guangzhou (CN)

(72) Inventor: Zheng LIU, Yiyang (CN)

(73) Assignee: Guangzhou Zhongtianxin Electronic Technology Co.,Ltd, Guangzhou (CN)

(21) Appl. No.: 18/424,512

(22) Filed: Jan. 26, 2024

(51) Int. Cl. A63F 13/98; H02J 7/00

(52) U.S. Cl. CPC A63F 13/98; H02J 7/0042

(57) ABSTRACT

The present invention relates to the technical field of charging stand and discloses a horizontal charging stand with high reliability and compatibility with PS5 and PS5 SLIM. It comprises a first main part (100), a second main part (200), and a connecting component (300). Among them, one end of the connecting component (300) and the first main part (100) are provided with the lower end of the first space (100a) side can be disassembled, and the other end of the connecting component (300) and the second main part (200) are provided with the lower end of the second space (200a) side can be disassembled.

### TECHNICAL FIELD

The present invention relates to the technical field of charging stand, more specifically to a horizontal charging stand.

### BACKGROUND

With the development of the gaming console industry, there is an increasing demand for horizontal placement from users. However, there are some issues with current products on the market. One of them is that many horizontal stands fail to provide sufficient stability, resulting in the device shaking or tilting during use. Additionally, some gaming console users may own both the PS5 and PS5 Slim consoles, but there is currently no charging stand available that can accommodate both models horizontally. This requires the production of two different stands to fit each model, leading to higher production costs for PS5/PS5 Slim charging stands.

### SUMMARY

The technical problem addressed by the present invention is that there is currently no horizontal stand on the market that can simultaneously accommodate two types of PS5/PS5 SLIM gaming consoles. As a result, two different stands need to be produced to accommodate both types of consoles, which leads to higher production costs. The present invention provides a horizontal charging stand with high reliability and compatible with PS5/PS5 SLIM consoles.

The technical solution adopted by the present invention to solve its technical problem is: constructing a horizontal charging stand, equipped with:
A first main part, one side of which is provided with a first space for placing a gaming device;
A second part, one side of which is provided with a second space for placing a gaming device; wherein,
The inner side of the second space and the inner side of the first space are arranged relatively;
A connecting component, one end of which and the first main part are provided with a lower end of the first space side can be disassembled,
The other end of the connecting component and the second main part are provided with a lower end of the second space side can be disassembled.

In some embodiments, the connecting component comprises a first connecting bracket and a second connecting bracket,
One end of the first connecting bracket and one end of the second connecting bracket can be disassembled,
The other end of the first connecting bracket and the first main part are provided with the lower end of the first space side can be disassembled,
The other end of the second connecting bracket and the second main part are provided with the lower end of the second space side can be disassembled.

In some embodiments, the first main part comprises at least a first bracket and a first slider,
The first slider is positioned on one side of the first bracket to form the first space,
One end of the first slider can move radially along the first bracket to expand the first space.

In some embodiments, There is a first opening on one side of the first bracket,
One end of the first slider is embedded into the first opening of the first bracket, and the end of the first slider can move radially within the first opening.

In some embodiments, at the lower end surface of the first opening is provided with a slot,
The back side of the first slider is provided with a convex rib which is matched with the slot,
The first slider can be moved through the convex rib and the slot of the first bracket.

In some embodiments, a first connecting end is arranged on the inner side of the first bracket, and the first connecting end is designed as an opening structure,
The other end of the first connecting bracket and the opening structure inserted into the first connecting end,
The first connecting end of the first connecting bracket and the first bracket can be disassembled.

In some embodiments, a first charging terminal and a second charging terminal are arranged on the outside of the first bracket,
The upper surfaces of the first charging terminal and the second charging terminal is designed as a circular arc for placing the game controller to be charged.

In some embodiments, the first charging terminal and the second charging terminal are each equipped with a Type-C slider and a Type-C slider fixing plate,
The Type-C slider is positioned on the upper surface of the Type-C slider fixing plate,
The Type-C slider fixing plate is positioned on the upper surface of the Type-C charging interface. The Type-C slider is used to adjust the position of the Type-C charging interface.

In some embodiments, the second main part comprises at least a second bracket and a second slider,
The second slider is positioned on one side of the second bracket to form the second space,
One end of the second slider can move radially along the second bracket to expand the second space.

In some embodiments, there is a second opening on one side of the second bracket,
One end of the second slider is embedded into the second opening of the second bracket. The end of the second slider can move radially within the second opening.

In some embodiments, there is a protruding locking strip in the middle of the inner side of the second opening,
The extension part of the second slider is equipped with a locking block in coordination with the locking strip,
The second slider can be movably positioned on the second bracket by the locking strip and the locking block.

In some embodiments, a second connecting end is arranged on the inner side of the second bracket, and the second connecting end is arranged as an opening structure,
The other end of the second connecting bracket and the opening structure inserted into the second connecting end,
The second connecting bracket and the second connecting end of the second bracket can be disassembled.

In some embodiments, the second space is provided with a support member with a large end and a small end,
The support member is used to bear the gaming device placed in the second space.

In some embodiments, a fixed plate extending upward is arranged on the upper surface of the second bracket, and this fixed plate is securely placed in the second space with the help of screws to hold the gaming device.

In some embodiments, a USB power cable is arranged at the bottom of the first bracket, and the USB power cable is connected to an external power cable, providing a charging power supply for both the first charging terminal and the second charging terminal.

In some embodiments, the first bracket is designed as a hollow structure,
A fan for heat dissipation is arranged in the inner hollow structure.

The horizontal charging stand of the present invention comprises a first main part, a second main part and connecting components, wherein one end of the connecting component and the first main part are provided with the lower end of the first space side that can be disassembled, and the other end of the connecting component and the second main part are provided with the lower end of the second space side that can be disassembled. Compared to the prior art, the connecting component can be disassembled in the first space of the first main part and the opposite side of the second space of the second main part allows for increased stability of the horizontal charging stand. Additionally, it is compatible with two types of models, reducing production costs and meeting the stability requirements of users for the horizontal charging stand. It also caters to users who own both the PS5 controller and the PS5 Edge controller, ensuring maximum compatibility with various product application scenarios.

### BRIEF DESCRIPTION OF DRAWINGS

In order to explain more clearly the technical solutions in the embodiments of the present invention, a brief introduction of the accompanying drawings required in the description of the embodiment or the prior art will be given below:

FIG. 1 is a three-dimensional diagram of an embodiment of a horizontal charging stand provided by the present invention;

FIG. 2 is a three-dimensional diagram of an embodiment of a horizontal charging stand provided by the present invention;

FIG. 3 is an explosion diagram of an embodiment of a horizontal charging stand provided by the present invention;

FIG. 4 is an explosion diagram of another embodiment of a horizontal charging stand provided by the present invention;

FIG. 5 is an explosion diagram of yet another embodiment of a horizontal charging stand provided by the present invention;

FIG. 6 is the explosion diagram of the fourth embodiment of the horizontal charging stand provided by the present invention;

FIG. 7 is a three-dimensional diagram of the first main part of the present invention;

FIG. 8 is a three-dimensional diagram of another embodiment of the first main part provided by the present invention;

FIG. 9 is a three-dimensional diagram of another embodiment of the first main part provided by the present invention;

FIG. 10 is a three-dimensional diagram of the fourth embodiment of the first main part provided by the present invention;

FIG. 11 is a three-dimensional diagram of the second main part of the present invention;

FIG. 12 is a three-dimensional diagram of an embodiment of the second slider provided by the present invention;

FIG. 13 is a three-dimensional diagram of an embodiment of a connecting component provided by the present invention;

FIG. 14 is a three-dimensional diagram of an embodiment of the first connecting bracket provided by the present invention;

FIG. 15 is a three-dimensional diagram of an embodiment of the second connecting bracket provided by the present invention;

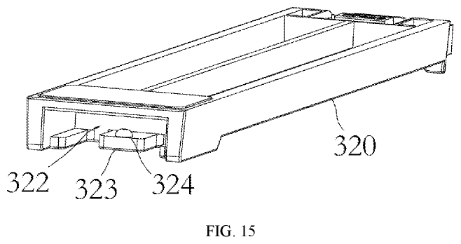

FIG. 16 is a three-dimensional diagram of an embodiment of the first charging terminal provided by the present invention.

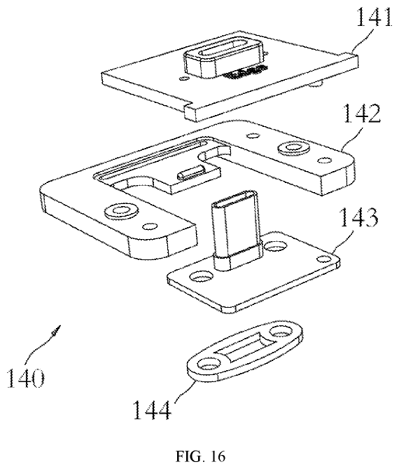

### DETAILED DESCRIPTION OF THE EMBODIMENTS

A clear and complete description of the technical solutions in the present invention will be given below, in combination with the drawings corresponding to the embodiments of the present invention.

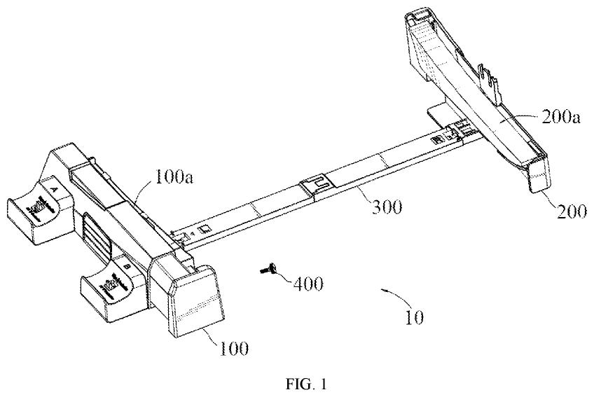

In the first embodiment of the horizontal charging stand in the present invention, as shown in FIGS. 1 to 6, the horizontal charging stand 10 comprises a first main part 100, a second main part 200, and a connecting component 300.

The first main part 100 and the second main part 200 have an irregular rectangular structure,
The upper surfaces of the first main part 100 and the second main part 200 are open structure placement space, the placement space is “L” shape, for the placement of gaming device,
The gaming device can be a PS5/PS5 SLIM console;

The connecting component 300 has a flat rectangular structure, and its two ends are positioned inside the first main part 100 and the second main part 200, specifically in the relative inner sides of the two placement spaces (100a, 200a), and can be disassembled with the first main part 100 and the second main part 200.

To be more specific, as shown in FIG. 1, one side of the first main part 100 is equipped with the first space 100a for placing gaming device;

As shown in FIG. 1, one side of the second main part 200 is equipped with the second space 200a for placing gaming device;

The inner side of the second space 200a is positioned opposite to the inner side of the first space 100a;

It should be noted that both sides of the first main part 100 and the second main part 200 are considered as inner sides;

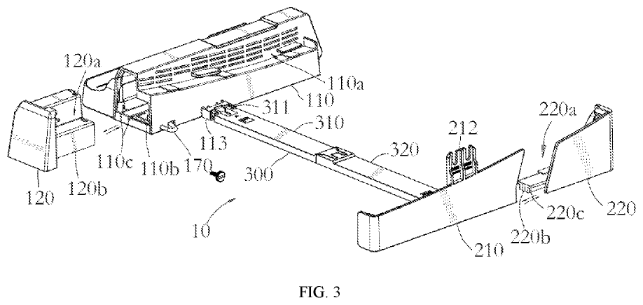

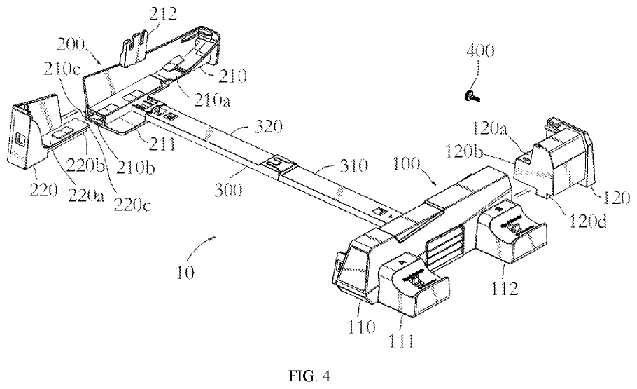

Further, as shown in FIGS. 3 and 4, one end (corresponding to 311) of the connecting component 300 and the first main part 100 set the lower end of the first space 100a side can be disassembled,
The other end (corresponding to 321) of the connecting component 300 and the second main part 200 set the lower end of the second space 200a side can be disassembled.

With this technical solution, the connecting component 300 can be disassembled on the opposite side of the first main part 100 and the second main part 200. By setting the connecting component 300, the stability of the horizontal stand can be increased. Furthermore, this design allows for compatibility with two different console models (PS5/PS5 Slim), reducing production costs. This solution meets the user's requirements for stability in a horizontal stand and also accommodates users with different types of game controllers, including the PS5 controller and the PS5 Edge controller. This maximizes compatibility with various types of products and application scenarios.

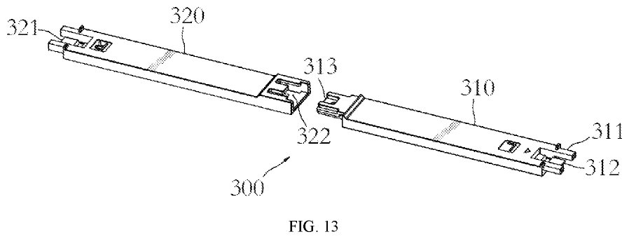

In some embodiments, as shown in FIG. 3, FIG. 4, and FIG. 13, in order to improve the stability of the charging stand during use, the connecting component 300 is equipped with a first connecting bracket 310 and a second connecting bracket 320,
Both the first connecting bracket 310 and the second connecting bracket 320 are designed as flat rectangular structures;

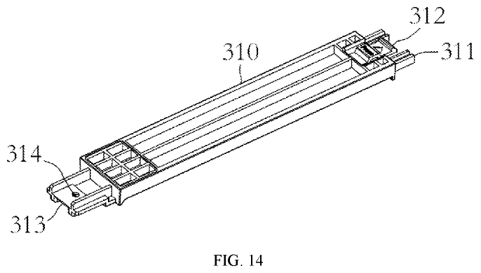

As shown in FIG. 14, one end of the first connecting bracket 310 is designed as an extension structure 313, and a clamping hole 314 is opened in the extension structure 313,
One end of the second connecting bracket 320 is designed as a concave structure 322, a connecting piece 323 is arranged in the concave structure 322, and a protruding cylindrical block 324 on the inner side of the connecting piece 323;

Specifically, one end 313 (corresponding to the extension structure) of the first connecting bracket 310 and one end 322 of the second connecting bracket 320 can be disassembled, that is, the extension structure 313 of the first connecting bracket 310 is inserted into the concave structure 322 of the second connecting bracket 320, and the protruding cylindrical block 324 of the connecting piece 323 is inserted into the clamping hole 314 opened in the extension structure 313, thereby achieving a detachable connection structure;

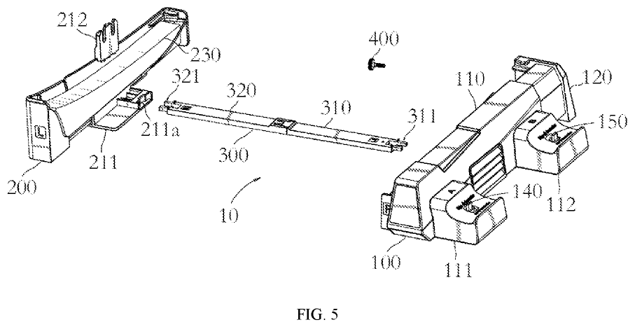

Furthermore, as shown in FIG. 3 and FIG. 5, the other end 311 of the first connecting bracket 310 is embedded in the lower end (corresponding to 113) of the first space 100a on one side of the first main part 100, so that the first connecting bracket 310 and the first main part 100 can be disassembled,
As shown in FIG. 5, the other end 321 of the second connecting bracket 320 is embedded in the lower end 211 of the second space 200a on one side of the second main part 200, so that the second connecting bracket 320 and the second main part 200 can be disassembled. Specifically, on the basis of two conventional horizontal charging stands, the first connecting bracket 310 and the second connecting bracket 320 are set up to increase the stability when placing the product, by coordinating the first connecting bracket 310, the second connecting bracket 320, the first main part 100, and the second main part 200.

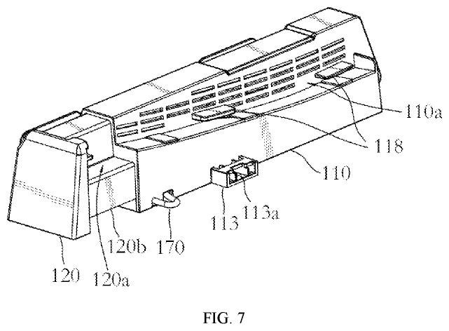

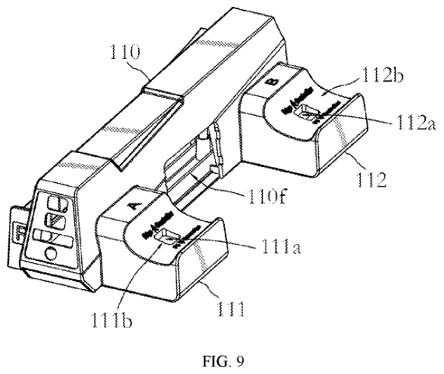

In some embodiments, as shown in FIG. 3, to improve compatibility with both PS5 and PS5 Slim models, a first bracket 110 and a first slider 120 can be set in the first main part 100. The first bracket 110 is designed as a hollow structure 110f, as shown in FIG. 9,
As shown in FIG. 7, a recessed first placement space 110a is formed on the inner side of the first bracket 110. A locating block 118 that extends into the first placement space 110a is set within the first bracket 110. The locating block 118 can be used to position and fix the bottom of the PS5 and PS5 Slim;

Furthermore, a recessed second placement space 120a is formed on the inner side of the first slider 120;

Whereas, one end 120b of the first slider 120 is set on one side of the first bracket 110. The first placement space 110a of the first bracket 110 and the second placement space 120a of the first slider 120 cooperate to form a first space 100a that can be used to place the PS5 and PS5 Slim gaming consoles,
When the PS5 or PS5 Slim gaming consoles are placed in the first space 100a, they can be fixed onto the first bracket 110 using a screw 400;

In this arrangement, one end 120b of the first slider 120 can move radially along the first bracket 110. By moving the end 120b of the first slider 120 along the outer side of the first bracket 110, it expands the first space 100a, allowing for adjustments to accommodate the different lengths of the PS5 and PS5 Slim models. This improves the compatibility of the charging stand for placing different console models.

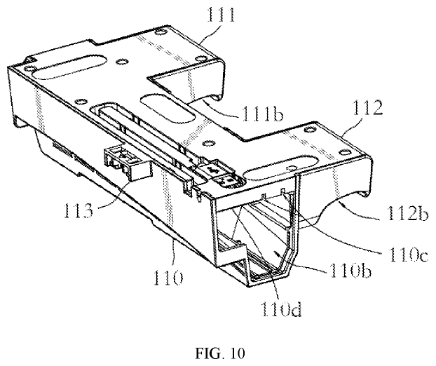

In some embodiments, as shown in FIGS. 9 and 10, in order to improve the reliability of the cooperation between the first slider 120 and the first bracket 110, a first opening 110b can be provided on one side of the first bracket 110;

Specifically, as shown in FIG. 3, one end 120b of the first slider 120 is embedded into the first opening 110b of the first bracket 110. When the one end 120b of the first slider 120 is completely embedded into the first opening 110b, the terminal face of the first slider 120 (that is, the adjacent terminal face of 120b) is in contact with the first opening 110b of the first bracket 110. At this time, the first space 100a is in the minimum state;

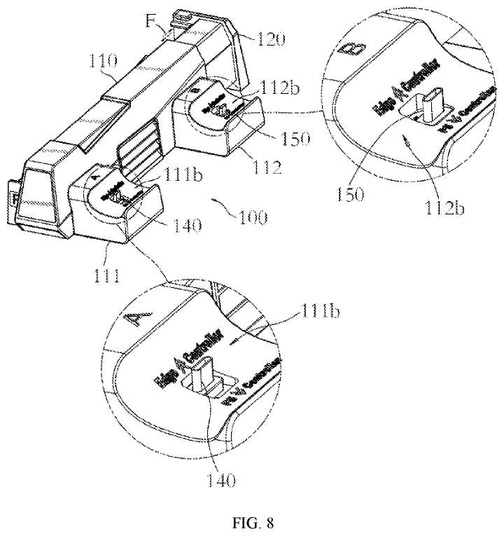

When one end 120b of the first slider 120 radially moves within the first opening 110b of the first bracket 110 (as shown as F in FIG. 8), the terminal face of the first slider 120 (i.e., the adjacent terminal face of 120b) separates from the first opening 110b of the first bracket 110. When the terminal face of the first slider 120 (i.e., the adjacent terminal face of 120b) is at its furthest position, the first space 100a is in the maximum state;

That is, by radially moving one end 120b of the first slider 120 within the first opening 110b of the first bracket 110 to extend the first space 100a, thereby changing the size of the first space 100a.

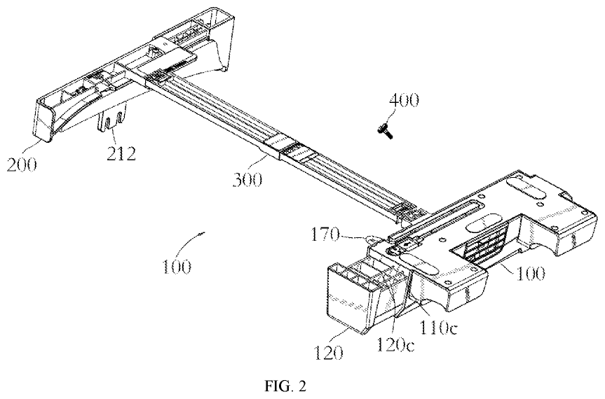

In some embodiments, as shown in FIG. 10, to improve the reliability of the relative movement between the first slider 120 and the first bracket 110, two adjacent slots 110c can be provided on the lower end of the first opening 110b as limiting strips 110d,
As shown in FIG. 2, there are two convex ribs 120c on the back of the first slider 120, which cooperate with the slots 110c,
And as shown in FIG. 4, there is a limiting member 120d on the lower front side of one end 120b of the first slider 120,
One end 120b of the first slider 120 is embedded in the first opening 110b, and the convex rib 120c of the first slider 120 is correspondingly embedded in the slot 110c of the first bracket 110, so that the convex rib 120c of the first slider 120 can be set flexibly with the slot 110c of the first bracket 110;

Furthermore, the limiting member 120d and the limiting strips 110d cooperate with each other to limit the movement direction of the first slider 120 through the slot 110c. By combining the limiting member 120d and the limiting strips 110d, the maximum moving distance of the first slider 120 can be limited to prevent it from disengaging from the first opening 110b during the relative movement between the first slider 120 and the first bracket 110.

In some embodiments, as shown in FIGS. 3, 7, and 10, to improve the convenience of assembly between the first bracket 110 and the first connecting bracket 310, a first connecting end 113 can be provided on the inside of the first bracket 110. As shown in FIG. 7, the first connecting end 113 is located at the lower end of the first placement space and is designed as an opening structure 113a,
Specifically, as shown in FIGS. 3 and 7, the other end 311 of the first connecting bracket 310 and the opening structure 113a inserted into the first connecting end 113. The first connecting bracket 310 and the first bracket 110 are held together by a locking mechanism, allowing the first connecting end 113 of the first bracket 110 can be disassembled.

In some embodiments, as shown in FIGS. 5, 6, and 8, in order to improve the reliability of the charging stand for placing game controllers, first charging terminal 111 and second charging terminal end 112 can be arranged on the outside of the first bracket 110,
Specifically, as shown in FIGS. 8 and 9, the upper surface of the first charging terminal 111 is set as a circular arc shape 111b,
The upper surface of the second charging terminal 112 is also set as circular arc shape 112b. These circular arc shape charging terminals (1l1b, 112b) can be used to place game controllers for charging, and the curved surface is compatible with the structural design of both new and old controllers.

In some embodiations, as shown in FIG. 8 and FIG. 14, in order to improve the compatibility of the charging stand with different models of game controllers, a Type-C charging module (140, 150) can be respectively installed in the first charging terminal 111 and the second charging terminal 112. The Type-C charging module (140, 150) includes at least a Type-C slider 141 and a Type-C slider fixing plate 142,
The Type-C slider 141 is positioned on the upper surface of the Type-C slider fixing plate 142,
The Type-C slider fixing plate 142 is positioned on the upper surface of the Type-C charging interface 143. The Type-C slider 141 is used to adjust the position of the Type-C charging interface 143.

Referring to the enlarged view in FIG. 8, the position of the Type-C charging module 140 is on the inner side of the opening 111a of the first charging terminal 111, which is closer to one side of the first bracket 110,
The position of the Type-C charging module 150 is on the inner side of the opening 112a of the second charging terminal 112, which is farther away from the first bracket 110;

In both cases, by moving the Type-C slider 141, the Type-C charging interface 143 can be adjusted, thereby changing its position within the opening 111a of the first charging terminal 111 to adapt to game controllers with charging ports located at different positions. This allows for the placement of both old and new models of controllers, effectively reducing the production cost of the PS5 game console dock.

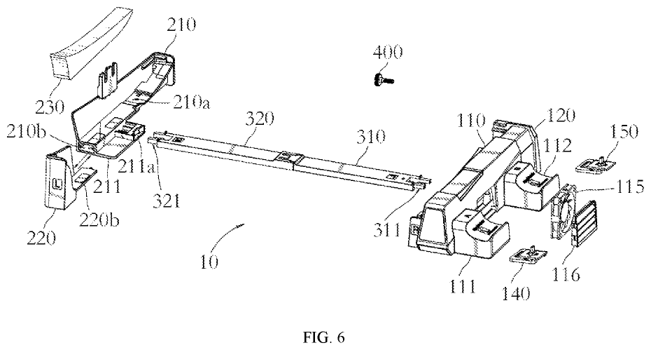

In some embodiments, as shown in FIGS. 4 and 6, to improve the compatibility of the charging stand with both the PS5 and PS5 SLIM models, the second main part 200 includes at least a second bracket 210 and a second slider 220. The inner side of the first bracket and the second bracket 210 form a third placement space 210a with a recess,
The inner side of the second slider 220 forms a fourth placement space 220a with a recess;

The second slider 220 is positioned on one side of the second bracket 210 and cooperates with the second bracket 210 to form the third placement space 210a of the second slider 220 and the fourth placement space 220a of the second bracket 210, thus forming a second space 200a that can be used to place the PS5 and PS5 SLIM game consoles,
Specifically, one end 220b of the second slider 220 is movable radially along the second bracket 210, and the second space 200a can be expanded by moving the one end 220b of the second slider 220 along the outer side of the second slider 220, thereby adjusting the size of the second space 200a to adapt to the length of the PS5 and PS5 SLIM models, and improving the compatibility of the charging stand for different models.

In some embodiments, as shown in FIG. 6, in order to improve the reliability of the relative movement between the second slider 220 and the second bracket 210, a second opening 210b can be provided on one side of the second bracket 210,
One end 220b of the second slider 220 is embedded into the second opening 210b of the second bracket 210. When the one end 220b of the second slider 220 is fully inserted into the second opening 210b and the end face 220f (i.e. the adjacent end face of 220b) of the second slider 220 is abutted against the second opening 210b of the second bracket 210, the second space 200a is in its minimum state;

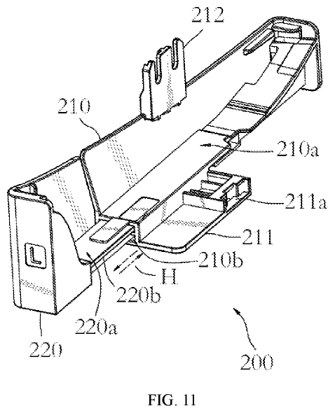

One end 220b of the second slider 220 can move radially within the second opening 210b (H as shown in FIG. 11). When one end 220b of the second slider 220 moves radially within the second opening 210b, the end face 220f of the second slider 220 (i.e., the end face adjacent to 220b) separates from the second opening 210b of the second bracket 210, and the end face 220f of the second slider 220 (i.e., the end face adjacent to 220b) is at its furthest end, thus allowing the second space 200a to be in its largest state;

That is, one end 220b of the second slider 220 can move radially in the second opening 210b of the second bracket 210 to extend the second space 200a, thereby changing the size of the second space 200a.

In some embodiments, as shown in FIG. 6, in order to improve the reliability of the relative movement between the second slider 220 and the second bracket 210, protruding locking strips 210c can be provided in the middle section on the inner side of the second opening 210b. Specifically, two locking strips 210c are arranged opposite to each other on the inner side of the second opening 210b;

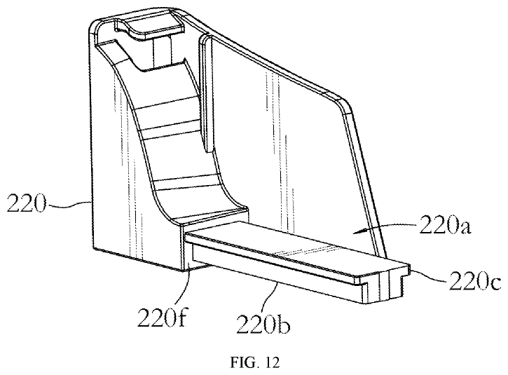

Furthermore, as shown in FIG. 12, locking blocks 220c are provided on both sides of the upper end of the extension part 220b of the second slider 220. The locking blocks 220c can cooperate with the locking strips 210c and provide positioning and limiting for the locking blocks 220c;

As shown in FIG. 4, the locking blocks 220c of the second slider 220 and the locking strips 210c of the second bracket 210 are movably arranged, enabling relative movement between the second slider 220 and the second bracket 210;

In other words, when the extension part 220b of the second slider 220 moves radially along the locking blocks 220c of the second bracket 210, the locking blocks 220c of the second slider 220 moves radial along the second opening 210b of the second bracket 210 to expand the second space 200a. By changing the size of the second space 200a, the charging stand can be compatible with different models such as PS5 and PS5 Slim by adapting to their lengths, thereby improving the compatibility of the charging stand for different models.

In some embodiments, as shown in FIGS. 4, 5, 6, and 11, in order to improve the convenience of assembling the second bracket 210 and the second connecting bracket 310, a second connecting end 211 can be provided on the inner side of the second bracket 210. The second connecting end 211 is positioned at the lower end of the second placement space 210a and its outer end is designed as an opening structure 211a,
Specifically, as shown in FIG. 5 and FIG. 6, the other end 321 of the second connecting bracket 320 and the opening structure 211a stuck into the second connecting end 211, that is, the second connecting bracket 320 and the second bracket 210 are matched by means of a locking mechanism, so that the second connecting bracket 320 and the second connecting end 211 of the second bracket 210 can be disassembled.

In some embodiments, as shown in FIGS. 5 and 6, the reliability of placing the PS5/15-PS5 SLIM game console can be improved by setting up a support member 230 with a large end and a small end inside the second space 200a. The support member 230 is snugly placed in the second space 200a, and is used to support the gaming devices placed inside the second space 200a.

In some embodiments, as shown in FIGS. 5, 6, and 11, to enhance the stability of placing the PS5/15-PS5 SLIM game console, an upwardly extending fixing plate 212 can be set on the upper surface of the second bracket 210. The fixing plate 212 has two fixing slots opened at the upper end, where the fixing ports of the PS5/15-PS5 SLIM game console are engaged, and then fix the gaming devices placed inside the second space 200a by coordinating with the screws 400 and the upper fixing slots of the fixing plate 212.

In some embodiments, as shown in FIGS. 2 and 3, a USB power cable 170 is installed at the bottom of the first bracket 110, where the USB power cable 170 is electrically connected to an external power source or to a charging stand to provide power for the first charging terminal 111 and the second charging terminal 112, enabling the charging of the PS5 controller and PS5 Edge controller.

In some embodiments, as shown in FIG. 6, to improve the heat dissipation effect of the charging stand, a fan 115 can be installed within the first bracket 110. The first bracket 110 is designed with a hollow structure 110f, and fan 115 is installed in the hollow structure 110f of the first bracket 110;

A partition net 116 is also arranged on the outside of the fan 115.

The above embodiments of the present invention are described in conjunction with the attached drawings. However, the present invention is not limited to the specific embodiments described above. The specific embodiments is merely illustrative, not restrictive. Those of ordinary skill in the art can also make many forms without leaving the scope of protection provided by the purpose and claims of the present invention. These are within the protection of the present invention.

What is claimed is:

1. A horizontal charging stand, which is characterized in that:
A first main part, one side of which is provided with a first space for placing a gaming device;
A second part, one side of which is provided with a second space for placing a gaming device; wherein,
The inner side of the second space and the inner side of the first space are arranged relatively;
A connecting component, one end of which and the first main part are provided with a lower end of the first space side can be disassembled,
The other end of the connecting component and the second main part are provided with a lower end of the second space side can be disassembled.

2. The horizontal charging stand, as described in claim 1 is characterized in that:
The connecting component comprises a first connecting bracket and a second connecting bracket,
One end of the first connecting bracket and one end of the second connecting bracket can be disassembled,
The other end of the first connecting bracket and the first main part are provided with the lower end of the first space side can be disassembled,
The other end of the second connecting bracket and the second main part are provided with the lower end of the second space side can be disassembled.

3. The horizontal charging stand, as described in claim 2 is characterized in that:
The first main part comprises at least a first bracket and a first slider,
The first slider is positioned on one side of the first bracket to form the first space,
One end of the first slider can move radially along the first bracket to expand the first space.

4. The horizontal charging stand, as described in claim 3 is characterized in that:
There is a first opening on one side of the first bracket,
One end of the first slider is embedded into the first opening of the first bracket, and the end of the first slider can move radially within the first opening.

5. The horizontal charging stand, as described in claim 4 is characterized in that:
At the lower end surface of the first opening is provided with a slot,
The back side of the first slider is provided with a convex rib which is matched with the slot,
The first slider can be moved through the convex rib and the slot of the first bracket.

6. The horizontal charging stand, as described in claim 5 is characterized in that:
A first connecting end is arranged on the inner side of the first bracket, and the first connecting end is designed as an opening structure,
The other end of the first connecting bracket and the opening structure inserted into the first connecting end,
The first connecting end of the first connecting bracket and the first bracket can be disassembled.

7. The horizontal charging stand, as described in claim 6 is characterized in that:
A first charging terminal and a second charging terminal are arranged on the outside of the first bracket,
The upper surfaces of the first charging terminal and the second charging terminal is designed as a circular arc for placing the game controller to be charged.

8. The horizontal charging stand, as described in claim 7 is characterized in that:
The first charging terminal and the second charging terminal are each equipped with a Type-C slider and a Type-C slider fixing plate,
The Type-C slider is positioned on the upper surface of the Type-C slider fixing plate,
The Type-C slider fixing plate is positioned on the upper surface of the Type-C charging interface; The Type-C slider is used to adjust the position of the Type-C charging interface.

9. The horizontal charging stand, as described in claim 2 is characterized in that:
The second main part comprises at least a second bracket and a second slider,
The second slider is positioned on one side of the second bracket to form the second space,
One end of the second slider can move radially along the second bracket to expand the second space.

10. The horizontal charging stand, as described in claim 9 is characterized in that:
There is a second opening on one side of the second bracket,
One end of the second slider is embedded into the second opening of the second bracket; The end of the second slider can move radially within the second opening.

11. The horizontal charging stand, as described in claim 10 is characterized in that:
There is a protruding locking strip in the middle of the inner side of the second opening,
The extension part of the second slider is equipped with a locking block in coordination with the locking strip,
The second slider can be movably positioned on the second bracket by the locking strip and the locking block.

12. The horizontal charging stand, as described in claim 11 is characterized in that:
A second connecting end is arranged on the inner side of the second bracket, and the second connecting end is arranged as an opening structure,
The other end of the second connecting bracket and the opening structure inserted into the second connecting end,
The second connecting bracket and the second connecting end of the second bracket can be disassembled.

13. The horizontal charging stand, as described in claim 12 is characterized in that:
The second space is provided with a support member with a large end and a small end,
The support member is used to bear the gaming device placed in the second space.

14. The horizontal charging stand, as described in claim 13 is characterized in that:
A fixed plate extending upward is arranged on the upper surface of the second bracket,
and this fixed plate is securely placed in the second space with the help of screws to hold the gaming device.

15. The horizontal charging stand, as described in claim 8 is characterized in that:
A USB power cable is arranged at the bottom of the first bracket, and the USB power cable is connected to an external power cable, providing a charging power supply for both the first charging terminal and the second charging terminal.

16. The horizontal charging stand, as described in claim 15 is characterized in that:
The first bracket is designed as a hollow structure,
A fan for heat dissipation is arranged in the inner hollow structure.
